(19) United States
(12) Patent Application Publication
(10) Pub. No.: US 2008/0028952 A1
(43) Pub. Date: Feb. 7, 2008

(54) Compactor construction

(76) Inventor: Terry L. Duperon, Saginaw, MI (US)

Correspondence Address: McCulloch PLC, Suite 1, 5291 Colony Drive North, Saginaw, MI, 48638, US

(21) Appl. No.: 11/497,821

(22) Filed: Aug. 2, 2006

(51) Int. Cl. B30B 9/02

(52) U.S. Cl. 100/106

(57) ABSTRACT

A compactor for compacting and dewatering debris comprises a housing having an inlet for enabling debris to be delivered to forwarding augers which forward the debris to a compaction chamber at the discharge end of the housing. The chamber has an outlet opening of less cross-sectional area than that of the chamber, thereby ensuring sufficient compaction of the discharged debris that it can pass through the opening. The opening is formed in an elastic wall which distorts to some extent and imposes a resistive force on the movement of debris through the opening, thereby further compacting the debris as it passes through the opening. Debris passing through the chamber may be sprayed with water to remove sludge-like substances which otherwise would cling to other types of debris.

This disclosure relates to apparatus for compacting and dewatering refuse or other compactable material.

### BACKGROUND OF THE APPARATUS

It is common practice to install refuse or trash collection apparatus in a flowing stream for the purpose of removing trash from the stream so as to avoid such trash entering pumps, clogging screens, or otherwise interfering with or damaging downstream equipment. Examples of such trash collecting apparatus are disclosed in U.S. Pat. Nos. 4,709,804 and 5,425,875.

Trash intercepted and removed from a stream typically is discharged to a collector from which it is conveyed or otherwise transported to a disposal site. Unless the trash is compacted and dewatered, the bulkiness and weight of such trash presents problems in transporting and disposing of such trash.

Apparatus constructed in accordance with the invention compacts and dewaters trash removed from a flowing stream, thereby minimizing the objectionable characteristics of transporting and compacting such trash.

### SUMMARY OF THE DISCLOSURE

Trash compaction apparatus constructed in accordance with the presently preferred embodiment of the invention is adapted to be located in a position to receive trash extracted from a flowing stream or other source and operate continuously to compact and dewater such trash substantially simultaneously with its removal from the stream, thereby effecting substantial economies in dealing with such trash.

The compacting apparatus comprises a housing for receiving material to be compacted, material forwarding means for forwarding the trash toward an outlet in the housing and applying a positive force on such trash as it moves it in a direction to be discharged from the housing. The outlet is so constructed and arranged as to apply a resistive force on the trash as it passes through the outlet, thereby enabling the combination of the trash forwarding force and the resistive force to effect compaction of the trash as it approaches and moves through the outlet.

The trash forwarding means comprises a pair of vertically spaced augers each of which has a longitudinally extending shaft on which a helical vane is secured. The two shafts are driven in opposite directions by a common drive motor, but the vanes are of opposite hand so that the auger simultaneously forwards trash in the housing toward the outlet. The vertical spacing between the augers is such that the vanes are interleaved with one another so as to be self cleaning thereby minimizing the possibility that debris will be able to stall either of the augers.

The augers are rotatably journaled by bearings which normally engage and provide support for those ends of the augers adjacent the housing outlet. However, the augers are displaceable vertically relative to their respective bearings in the event debris is required to pass between the vanes and the bearings.

The shaft of one of the augers preferably is coupled to a water source so that compacted material arriving at the housing outlet may be sprayed with water so as to enable certain kinds of debris to be flushed.

### THE DRAWINGS

Apparatus constructed in accordance with the presently preferred embodiment of the invention is illustrated in the accompanying drawings wherein:

FIG. 1 is an isometric view;

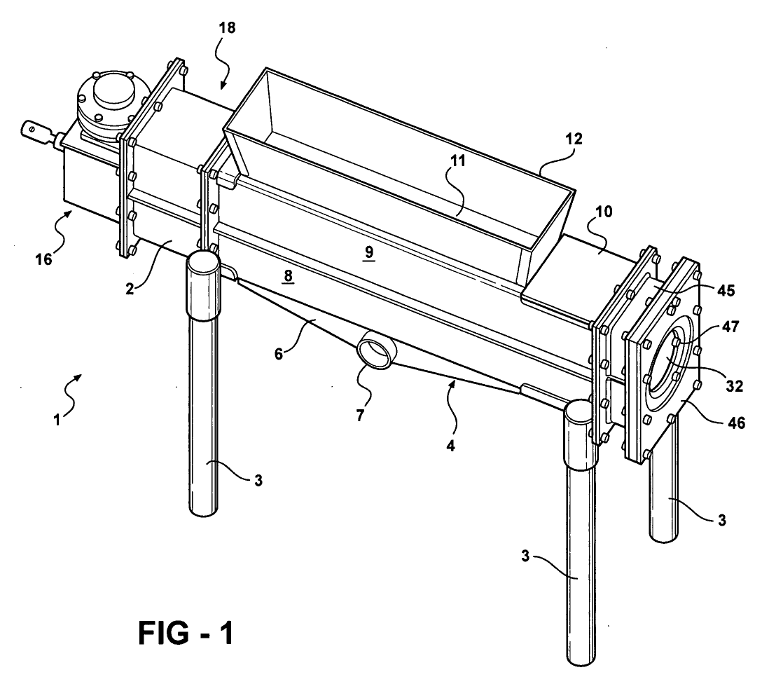

FIG. 2 is a top plan view;

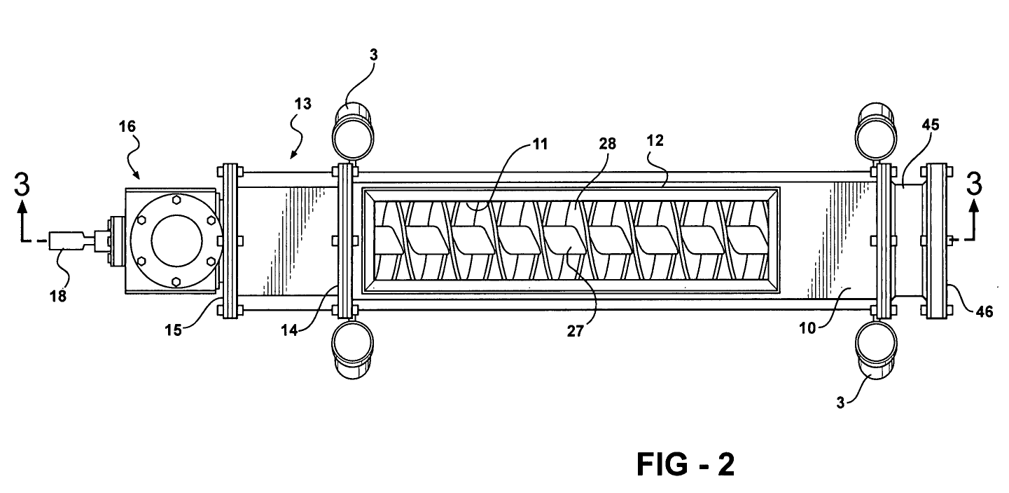

FIG. 3 is a sectional view, on an enlarged scale, taken on the line 3-3 of FIG. 2;

FIG. 4 is a sectional view, on an enlarged scale, taken the line 4-4 of FIG. 3; and

FIG. 5 is a fragmentary sectional view, on an enlarged scale, illustrating in greater detail the outlet end of the apparatus.

### THE DISCLOSED EMBODIMENT

The compacting apparatus is designated generally by the reference character 1 and comprises a frame 2 mounted on supporting legs 3. The frame supports a housing 4 having a downwardly converging bottom 5 and opposed side walls 6. One of the side walls has a drain opening 7. The side walls have upwardly extending extensions 8 and 9 which join a top wall 10 provided with an inlet 11. The inlet is bounded by upwardly extending guides 12 which guide debris (not shown) through the inlet 11 to the interior of the housing 4.

At one end of the housing is an enclosure 13 having end walls 14 and 15, the end wall 14 being bolted or otherwise secured to the housing 4. Bolted or otherwise secured to the end wall 15 is a support 16 for an electric drive motor (not shown) coupled to a gear reduction assembly 17 of known construction having a drive shaft 18 coupled to a driven shaft 19 which extends through a coupling 20 and a gear 21. The gear 21 meshes with a like gear 22 fixed on an offset shaft 23.

The gears 21 and 22 are coupled to debris forwarding means 24 comprising a pair of vertically spaced augers 25 and 26. The auger 25 has a longitudinally extending shaft 27 which is rockably connected to the shaft 23 in known manner. Fixed on the shaft 27 is a helical vane 28. The auger 26 has a hollow shaft 29 which parallels the shaft 27 and is rockably connected to the shaft 19. The shaft 29 has fixed thereon a helical vane 30. The pitch of the vanes 28 and 30 preferably is uniform. The interior of the hollow shaft 29 communicates with the coupling 20. To the coupling 20 is connected one end of a hose 31 the opposite end of which communicates with a source of water.

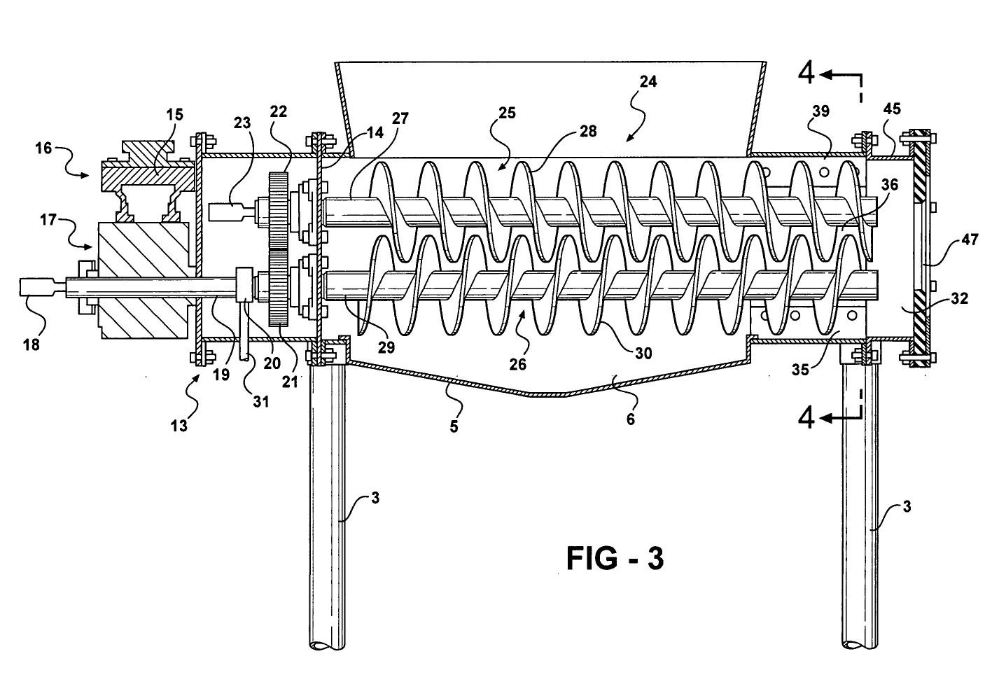

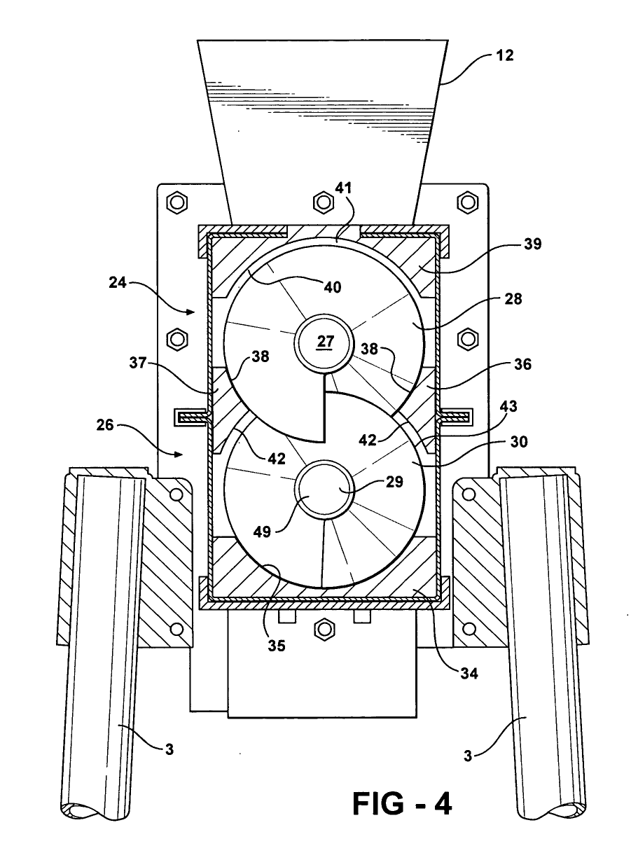

As is shown clearly in FIGS. 3 and 4 the vertical spacing between the augers is such that the vanes 28 and 30 are interleaved with one another. The peripheral edge of each vane projects toward, but terminates short of, the shaft of the adjacent auger. The vanes of the augers are axially spaced from one another. The gearing 21 and 22 effects driving of the respective augers in opposite directions. However, the vanes 28 and 30 are of opposite hand and are so assembled with the respective auger shafts that each vane simultaneously may exert a force on compactable material within the housing to forward the latter from left to right, as view in FIG. 3, and toward a compaction chamber 32 at that end of the housing remote from the driving gears 21 and 22. The construction and arrangement of the augers are such that the augers are self cleaning.

Auger bearing means are provided adjacent the discharge end of the housing 4. The bearing for the lower auger 26 comprises a block 34 (FIG. 4) of bearing material having an upwardly concave surface 35 formed on the same radius as that of the vane 30 and occupies a position to provide support for one or more convolutions of the vane 30. At a level above the bearing block 34 are two laterally spaced bearing blocks 36 and 37. Each of these blocks has an obliquely upward arcuate surface 38 formed on an arc corresponding to the radius of the vane 28. One or more convolutions of the vane 28 normally rest upon and are supported by the bearing blocks 36 and 37.

At a third level is a bearing block 39 which corresponds substantially to the block 34 except that the block 39 overlies the vane 28 of the upper auger 24. The block 39 has an arcuate surface 40 formed on an arc corresponding to the radius of the vane 28. The bearing block 39 does not normally bear upon the vane 28. Instead, there normally is a clearance 41 between the periphery of the vane 28 and the arcuate surface 40 of the block 39.

Each of the bearing blocks 36 and 37 has an obliquely downwardly facing arcuate surface 42. The position of the bearing blocks 36 and 37 is such that, normally, the periphery of the lower auger vane 26 is spaced from the arcuate surfaces 42 by a clearance 43.

As has been mentioned earlier, at the discharge end of the housing 4 is a compaction chamber 32 formed by closure walls 45. That end of the chamber which confronts the augers is open, whereas the opposite end is partially closed by a closure wall or block 46 formed of a known elastic, rubbery material having a central outlet opening 47 therein. The opening 47 has its center at the longitudinal axis of the chamber 32, but the cross-sectional area of the outlet opening 47 is less than that of the chamber.

At the free end of the hollow auger shaft 29 is a nozzle 49 which is inclined so as to be able to spray water which traverses the shaft 29 in the direction of the closure block 47.

In the operation of the apparatus the housing is so positioned that the inlet 11 defined by the guide walls 12 is in a position to receive debris. It is contemplated that the apparatus will be used in conjunction with a self cleaning trash rack of the kind shown in the aforementioned patents which can be placed in a flowing stream in such manner as to intercept trash and lift it from the stream to a position in which it is discharged automatically to the inlet 11. However, the apparatus disclosed herein can be used for compacting any kind of compactable material.

Debris entering the housing via the inlet 11 is entrained by the augers 25 and 26 which, when rotated, forward the entrained debris along a path in the direction of the chamber 32. As the debris is forwarded toward the chamber the debris is dewatered and compacted to some extent simply by its engagement with the augers. Eventually, debris reaches the discharge end of the housing and is introduced to the chamber 32. The debris soon will fill the chamber. The only escape path for the debris is through the outlet opening 47 in the closure block 46. Since the cross-sectional area of the opening is less than that of the chamber 32, debris introduced to the chamber 32 will be dewatered and compacted in the chamber until such time as the continuing admission of debris into the chamber causes the debris to force its way to the opening 47.

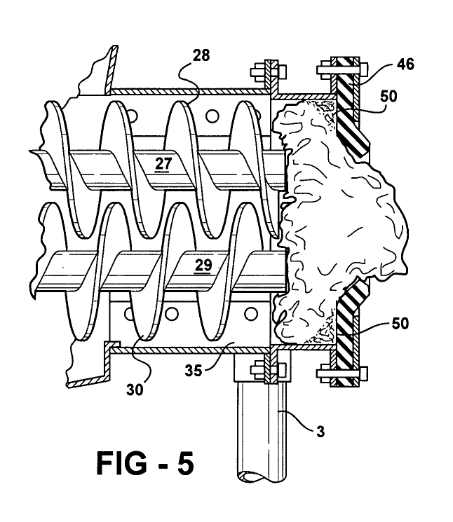

Since the quantity of debris introduced to the chamber has a larger cross sectional area than that of the opening 47, debris in the chamber will continue to be compacted. Eventually, the compacted material will force its way through the opening 47 and, in the process of passing through the opening, will displace the edges of the block adjacent the opening outwardly, or to the right as is indicated in FIG. 5. The elasticity of the block 46 will impose a resistive force on compacted material entering the opening 47, thereby further compacting the debris as it passes through the opening.

As the material continues to be forwarded to the chamber 32, it will fill the chamber in such manner as to form a tapered passageway 50, indicated in FIG. 5, through the chamber to the outlet opening 47. The compacted material forming such passageway will become virtually solid, thereby cooperating with the closure 46 to concentrate compaction of the debris as it is forced to move toward the outlet opening.

Trash in waste water streams frequently includes rags and textile materials which have a tendency to wrap around an auger shaft or vane. Should this occur the textile materials still will be forwarded to the compaction chamber 32. If a rag has become wrapped around a vane, it is possible for the rag to effect lifting of either or both of the augers off their respective bearing blocks a distance corresponding the clearances 41 and/or 42, thereby enabling the rag to pass between the bearings and the vanes without stalling the augers. The flexibility of the auger shafts is such as to permit the necessary vertical movements of the augers.

As the debris is compacted it also is dewatered. The water thus released from the debris may escape the housing through the discharge opening 7.

Some kinds of debris are sludge-like in form and will adhere to compacted debris. To minimize the sludge-like content of debris which is discharged from the compacting apparatus water may be sprayed from the nozzle 49 as the auger 26 rotates, thereby, in effect, washing such sludge-like material from the compacted debris.

Compacted debris discharged from the apparatus will be in log-like form which will occupy considerably less space than uncompacted debris would occupy and is considerably more solid than uncompacted debris. Such debris therefore lends itself well to placement in landfills and can be transported more easily by truck with fewer trips than otherwise would be required with uncompacted debris.

The disclosed embodiment is representative of a presently preferred form of the invention, but is intended to be illustrative rather than definitive thereof. The invention is defined in the claims.

I claim:

1. A compactor construction comprising a housing having an inlet for receiving material to be compacted and an outlet through which compacted material may be discharged; forwarding means within said housing; drive means coupled to said forwarding means for driving the latter in a direction to forward material in said housing along a path toward said outlet; and resistance means adjacent said outlet for imposing a resistive force on the movement of said material through said outlet thereby enabling material in said housing upstream from said outlet to be compacted by said forwarding means.

2. The construction according to claim 1 wherein said forwarding means comprises first and second augers each of which has an axially extending shaft having a helical vane fixed thereto, the vanes of said first and second augers being interleaved.

3. The construction according to claim 2 wherein adjacent vanes of each of said augers are axially spaced from one another.

4. The construction according to claim 2 including bearing means carried by said housing and underlying the respective augers, thereby supporting said augers from below.

5. The construction according to claim 4 wherein each of said augers is vertically movable a distance sufficient to enable each said auger to be lifted off the underlying bearing means.

6. The construction according to claim 5 including additional bearing means carried by said housing, said additional bearing means overlying and being spaced from said augers to limit said vertical movement of said augers.

7. The construction according to claim 1 wherein said resistance means comprises a wall having an opening therein through which compacted material from said housing may pass.

8. The construction according to claim 7 wherein said wall is formed of elastic material.

9. The construction according to claim 1 wherein said housing has a chamber adjacent said discharge end into which material from said housing may be delivered by said forwarding means, said chamber having a wall provided with an opening therein constituting said outlet, said chamber and said opening having respective cross-sectional areas, the cross-sectional area of said opening being less than that of said chamber.

10. The construction according to claim 9 wherein said wall is formed of elastic material enabling said opening resiliently to be expanded in cross-sectional area in response to the passage of compacted material therethrough, the expansion of said opening contributing to said resistance to the movement of said material through said outlet.

11. A compactor construction comprising a housing having an inlet for receiving material to be compacted and an outlet through which compacted material may be discharged; material forwarding augers within said housing, each said auger having a helical vane; auger drive means for simultaneously driving said augers in a direction to move material in said housing along a path toward said outlet; means forming a chamber in said housing upstream from said outlet into which material forwarded by said augers may be discharged, said chamber having a selected cross-sectional area; and closure means for said chamber having an opening therethrough forming said outlet, said opening having a cross-sectional area less than that of said chamber whereby material traversing said chamber in a direction toward said outlet becomes compacted in said chamber and forms a passageway leading to said outlet.

12. The construction according to claim 11 wherein said closure is elastic.

13. The construction according to claim 11 including bearing means carried by said housing in a position to support the vanes of said augers from below.

14. The construction according to claim 13 wherein each said auger has a shaft on which the associated vane is fixed, said shaft being vertically adjustable to enable said shaft to rise a distance to provide clearance between the vane on said shaft and the associated bearing means.

15. The construction according to claim 11 wherein there are two of said augers vertically spaced from one another.

16. The construction according to claim 15 wherein the vane of one of said augers is interleaved with the vane of the other of said augers.

17. The construction according to claim 11 wherein said auger drive means drives said augers in opposite directions.

18. The construction according to claim 17 wherein the vanes of said auger are of opposite hand.

19. The construction according to claim 14 wherein said vanes are of substantially uniform pitch.

20. The construction according to claim 11 wherein one of said auger shafts is hollow, means coupling said hollow shaft to a source of water, and nozzle means carried by said hollow shaft for spraying water from said shaft in a direction toward said outlet opening.
